(19) United States
(12) Patent Application Publication
(10) Pub. No.: US 2018/0078084 A1
(43) Pub. Date: Mar. 22, 2018

(54) METHOD OF POURING DRINK WITH MILK AND DRINK DISPENSER USING THE SAME

(71) Applicant: FUJI ELECTRIC CO., LTD., Kawasaki-shi (JP)

(72) Inventor: Kenya NAGAYOSHI, Nagoya-shi (JP)

(21) Appl. No.: 15/819,728

(22) Filed: Nov. 21, 2017

Related U.S. Application Data
(63) Continuation of application No. PCT/JP2016/063195, filed on Apr. 27, 2016.

(30) Foreign Application Priority Data
Jun. 2, 2015 (JP) 2015-112130

(51) Int. Cl. A47J 31/44; B67D 1/00; A23C 9/152

(52) U.S. Cl. CPC A47J 31/4496; B67D 1/0034; B67D 1/0046; A23C 2210/252; A47J 31/4489; A23C 2210/30; A23C 9/1524

(57) ABSTRACT

A method of pouring drink with milk includes pouring milk foam made by mixing heated steam, undiluted milk solution, and air into a drink container; and pouring liquid steam milk made by mixing heated steam and undiluted milk solution into the drink container after pouring the milk foam so as to provide drink with milk including the milk foam and the steamed milk, the drink being topped with the milk foam on a top layer in the drink container.

### CROSS-REFERENCE TO RELATED APPLICATION(S)

The present application claims priority to and incorporates by reference the entire contents of PCT International Application No. PCT/JP2016/063195 filed on Apr. 27, 2016.

### BACKGROUND

The present disclosure relates to a method of pouring drink with milk.

Initial machines of this kinds of drink dispenser to vend drinks with milk is configured to store dry milk powder in a storage because raw milk cannot be kept warm and stored, and pour liquid milk that is made by mixing the dry milk power supplied from the storage with hot water when a drink with milk is selected, but there is a disadvantage that the flavor of milk is faded with dry milk power. Accordingly, one has appeared in which concentrated raw milk is stored in cool temperature, and the cooled undiluted milk solution is warmed by being mixed with steam to be served (see, for example, Japanese National Publication of International Patent Application No. 2006-525052). According to Japanese National Publication of International Patent Application No. 2006-525052, it is disclosed that liquid steamed milk is made by mixing cooled undiluted milk solution with steam, foamy milk foam is made by mixing the cooled undiluted milk solution, steam, and air, and the liquid steamed milk and the foamy milk form are provided in a cup (drink container) to vend as hot milk (drink with milk).

### SUMMARY

According to an embodiment of the present disclosure, a method is disclosed of pouring drink with milk includes pouring milk foam made by mixing heated steam, undiluted milk solution, and air into a drink container; and pouring liquid steam milk made by mixing heated steam and undiluted milk solution into the drink container after pouring the milk foam so as to provide drink with milk including the milk foam and the steamed milk, the drink being topped with the milk foam on a top layer in the drink container.

Further, according to an embodiment of the present invention, a drink dispenser is disclosed including: an undiluted-solution storage unit that stores undiluted milk solution at cool temperature; a steam supplying unit that supplies heated steam; an air supplying unit that supplies compressed air; a mixing unit that is structured to be supplied with steam from the steam supplying unit, undiluted milk solution from the undiluted-solution storage unit, and compressed air from the air supplying unit, and that makes, when steam and undiluted milk solution are supplied, warmed liquid steamed milk by mixing the steam and the undiluted milk solution, and makes, when steam, undiluted milk solution, and compressed air are supplied, milk with foam warmed by the steam and foamed with the compressed air by mixing the steam, the undiluted milk solution, and the compressed air; a nozzle unit that pours the warmed liquid steamed milk that is made by the mixing unit; a foaming unit that increases foam in the milk with foam supplied from the mixing unit to make milk foam; a nozzle unit that pours the milk foam made by the foaming unit; and a control unit that has a liquid steamed milk pouring process in which steam and undiluted milk solution are supplied to the mixing unit, and liquid steamed milk made by the mixing unit is poured through the nozzle unit, and a milk foam pouring process in which steam, undiluted milk solution, and compressed air are supplied to the mixing unit, milk with foam that is made and foamed by the mixing unit is supplied to the foaming unit, and milk foam that is made by the foaming unit is poured through the nozzle unit, and that performs the liquid steamed milk pouring process and the milk foam pouring process to pour drink with milk into a drink container when a drink with milk is selected. Further, the control unit performs the milk foam pouring process and then the liquid steamed milk pouring process when a drink with milk is selected.

### BRIEF DESCRIPTION OF DRAWINGS

FIG. 1 is a perspective view of a drink dispenser to which a milk-beverage supplying device of an embodiment of the present disclosure is applied;

FIG. 2 is a schematic diagram schematically illustrating a configuration of the milk-beverage supplying device of the embodiment of the present disclosure;

FIG. 3 is a perspective view of the drink dispenser illustrated in FIG. 1 when viewed from a rear side;

FIG. 4 is a perspective view illustrating a plug constituting an undiluted-solution supplying unit;

FIG. 5 is a cross-sectional view schematically illustrating a configuration of the plug and a socket;

FIG. 6 is a perspective view illustrating a check valve structure constituting the undiluted-solution supplying unit;

FIG. 7 is a horizontal cross-sectional view of the check valve structure illustrated in FIG. 6;

FIG. 8 is a perspective view illustrating a check-valve main body constituting the check valve structure illustrated in FIG. 6 and FIG. 7;

FIG. 9 is a vertical cross-sectional view illustrating the check-valve main body illustrated in FIG. 8 when viewed from a left side;

FIG. 10 is a vertical cross-sectional view of the check-valve main body illustrated in FIG. 8 when viewed from a front side;

FIG. 11 is a perspective view of the socket;

FIG. 12 schematically illustrates main parts of the plug and socket when the plug is put into the socket, and a part (a) illustrates a state in which the plug is removed from the socket, and a part (b) illustrates a state in which the plug is inserted into the socket;

FIG. 13 is a cross-sectional view schematically illustrating a configuration of the plug and the socket.

FIG. 14 is a perspective view illustrating a mixing unit illustrated in FIG. 2;

FIG. 15 is a cross-sectional view illustrating the mixing unit illustrated in FIG. 2;

FIG. 16 is a perspective view illustrating a foaming unit illustrated in FIG. 2.

FIG. 17 is a cross-sectional view illustrating the foaming unit illustrated in FIG. 2.

FIG. 18 is a perspective view illustrating a nozzle unit illustrated in FIG. 2.

FIG. 19 is a cross-sectional view illustrating the nozzle unit illustrated in FIG. 2;

FIG. 20 is a perspective view illustrating an internal part of a nozzle main body illustrated in FIG. 18 and FIG. 19;

FIG. 21 is a perspective view illustrating a drink guiding unit illustrated in FIG. 20;

FIG. 22 is a perspective view illustrating a modification of the foaming unit; and

FIG. 23 is a perspective view illustrating a modification of the nozzle unit.

### DETAILED DESCRIPTION

For drinks with milk poured into a drink container, the drink quality is affected by visual impression (appearance). In the case of hot milk that is made by adding foamy milk foam to liquid steamed milk, when milk foam is put on top of a layer of liquid steamed milk, foam of uniform bubble size spread over the top layer of the drink with milk, and gives good visual impression (appearance), and therefore the drink quality is maintained. To thus maintain the drink quality, that is, to put foamy milk foam on top of a layer of liquid steamed milk, it is a common practice to pour foamy milk foam after liquid steamed milk is poured into a drink container. However, when liquid steamed milk is poured into an empty drink container, the steamed milk splashes to generate bubbles larger than bubbles in the milk foam, and these bubbles are vertically and horizontally linked to each other to make a lump of bubbles (for example, like a lump of bubbles blown by a crab) arising like a mountain. The lump of bubbles remains sticking out of a surface of milk foam without being covered by the milk foam that is poured subsequent thereto, and there is a problem that the visual quality is deteriorated. To solve this problem, suppressing the pouring amount and the pouring speed of liquid steamed milk per unit time can be considered, but if the pouring amount or the pouring speed per unit time is suppressed not to generate a lump of bubbles, it causes another problem that the vending time increases. Furthermore, to solve the above problem, providing a structure in which a nozzle from which liquid steamed milk is poured into a drink container is arranged to be movable in a vertical direction, and the nozzle is brought close to a bottom surface of the drink container when the liquid steamed milk is poured into the drink container, or a structure in which the nozzle is inclined so that liquid steamed milk hits a side wall of a drink container can be considered. However, the former one requires a mechanism to make the nozzle movable, and the latter one requires a mechanism to hold the drink container so as not to be toppled over by collision of the liquid steamed milk, and therefore there is a problem that increase cost cannot be avoided.

There is a need to provide a method of pouring drink with milk that enables to solve the above problems and to keep a drink quality with a simple structure, maintaining the vending time within predetermined time, and a drink dispenser using the same.

As a result of giving various considerations to solve the above problems, the inventors focused on a point that the mechanism of generating bubbles when steamed milk is poured into an empty drink container is involving air when steamed milk collides with the drink container and splashes, and achieved the following disclosure to suppress splashes of steamed milk when colliding with a drink container, and to prevent generation of bubbles by taking air therein.

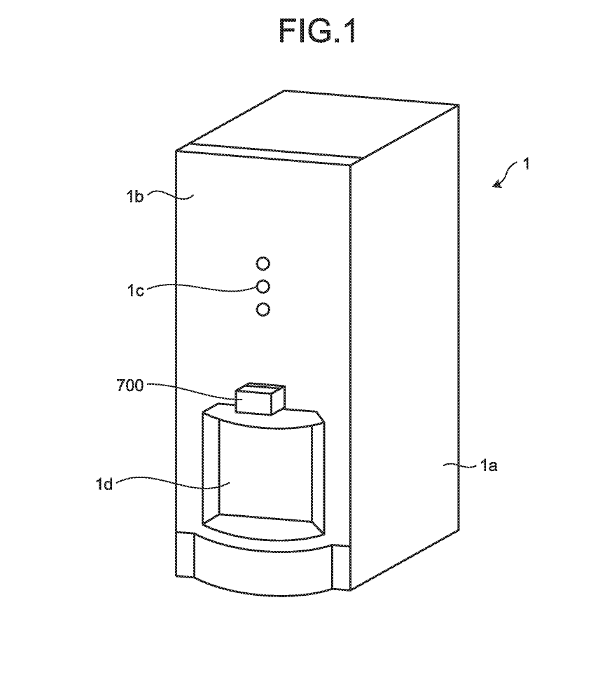

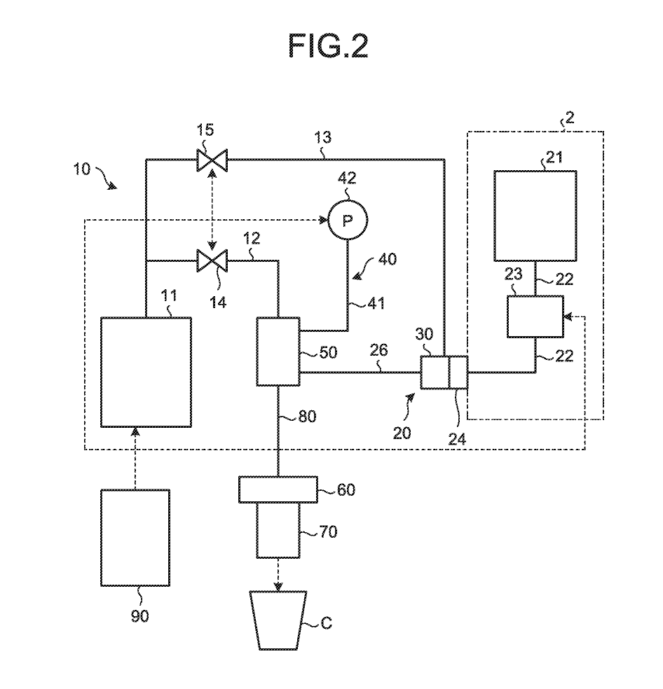

An embodiment of a drink dispenser according to the present disclosure is explained in detail below based on the drawings. A perspective view of the drink dispenser according to the embodiment of the present disclosure is illustrated in FIG. 1, and a configuration thereof is schematically illustrated in FIG. 2. A drink dispenser 1 given as an example herein is to pour drink with milk into a cup C (refer to FIG. 2) that is a drink container.

As illustrated in FIG. 1, the drink dispenser 1 includes a dispenser main unit 1a that is formed as a casing having an opening on a front side, and a front cover 1b that is supported on one side of the front side of the dispenser main unit 1a so as to close the opening on the front side, and an operation panel that includes a drink selection button 1c is arranged on a front surface (front side) of the front cover 1b. On the below side of the drink selection button 1c in the dispenser main unit 1a, a cup supporting table 1d to be a cup rest for the cup C (refer to FIG. 2), which is a drink container, is arranged, and on the above side of this cup supporting table 1d, a nozzle housing unit 700 to supply drink with milk is provided.

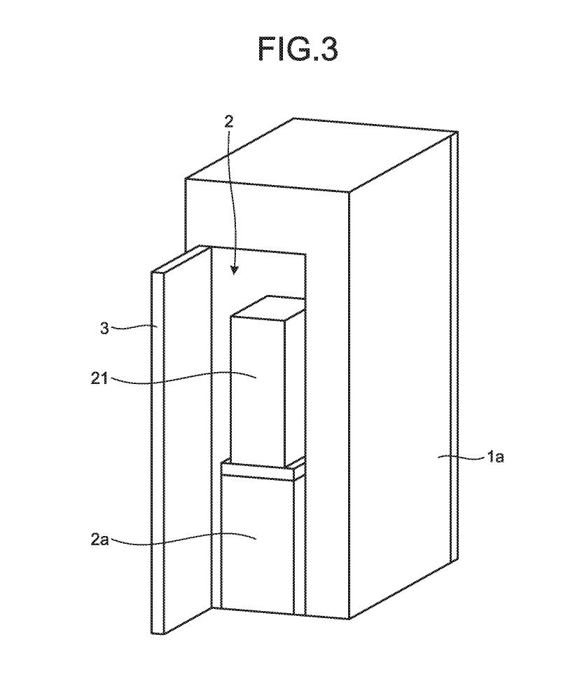

In the dispenser main unit 1a, components of the drink dispenser illustrated in FIG. 2, namely, a steam supplying unit (steam supplying means) 10, an undiluted-solution storage unit (undiluted-solution storage means) 20, an air supplying unit (air supplying means) 40, a mixing unit (mixing means) 50, a foaming unit (foaming means) 60, and the like are provided, and a control unit (control means) 90 that is constituted of a CPU having a program (process) to perform overall control of the respective components stored in a memory is built therein. A nozzle unit (nozzle means) 70 that constitutes one of the components of the drink dispenser 1 is housed in the nozzle housing unit 700 provided on the front side of the dispenser main unit 1a. Moreover, in the dispenser main unit 1a, a tube pump or the like to pump a predetermined amount of milk in a BIB (Bag In Box) 21 that is housed in a cool storage 2 (refer to FIG. 3), and the like are provided. The cool storage 2 is formed as a room with a heat insulating structure inside the dispenser main unit 1a of the drink dispenser 1, and is arranged to be openable with a rear cover 3 that has the heat insulating structure, and that is swingably provided on a rear side of the dispenser main unit 1a. The BIB 21 is refilled when the rear cover 3 is open. Note that 2a refers to a condensing unit of a freezer.

Next, the components of the drink dispenser 1 are explained with reference to FIG. 2. The steam supplying unit 10 includes a steam tank 11, a first steam-supplying tube 12, and a second steam-supplying tube 13. The steam tank 11, which is known in the art, is to generate pressurized steam.

The first steam-supplying tube 12 is connected to the steam tank 11 at one end, and is connected to the mixing unit 50 at the other end, thereby connecting the steam tank 11 and the mixing unit 50. In a middle of this first steam-supplying tube 12, a first steam-supplying valve 14 is provided. This first steam-supplying valve 14 opens and closes under a command given by a control unit (not illustrated). The first steam-supplying valve 14 allows the passage of pressurized steam in the first steam-supplying tube 12 when it is open. Moreover, the first steam-supplying valve 14 restricts the passage of the pressurized steam through the first steam-supplying valve 14 when it is closed.

The second steam-supplying tube 13 is connected to the steam tank 11 at one end, and is connected to a check valve structure 30 constituting the undiluted-solution storage unit 20 at the other end, thereby connecting the steam tank 11 and the check valve structure 30. Explanation of the check valve structure 30 is given later.

In the middle of the second steam-supplying tube 13, a second steam-supplying valve 15 is provided. This second steam-supplying valve 15 opens and closes under a command given by the control unit. The second steam-supplying valve 15 allows the passage of pressurized steam in the second steam-supplying tube 13 when it is open. Moreover, the second steam-supplying valve 15 restricts the passage of the pressurized steam through the second steam-supplying valve 15 when it is closed.

The undiluted-solution storage unit 20 includes the BIB 21, a tube pump 23, a plug 24, and a check valve structure 30.

The BIB 21 is constituted of a box-shaped container containing therein a bag-shaped container in which undiluted solution (hereinafter, may be referred to as “undiluted milk solution”) of drink with milk (hot milk) to be supplied to the cup C is filled. This BIB 21 is stored in the cool storage 2 that is integrated in the drink dispenser 1 described above, and is replenished by opening the rear cover 3.

The tube pump 23 is provided below the BIB 21 inside the cool storage 2. This tube pump 23 drives under a command given by the control unit, and pumps a predetermined amount of the undiluted milk solution in the BIB 21, when driven, by squeezing a tube 22 connected to the BIB 21 with multiple rollers or the like.

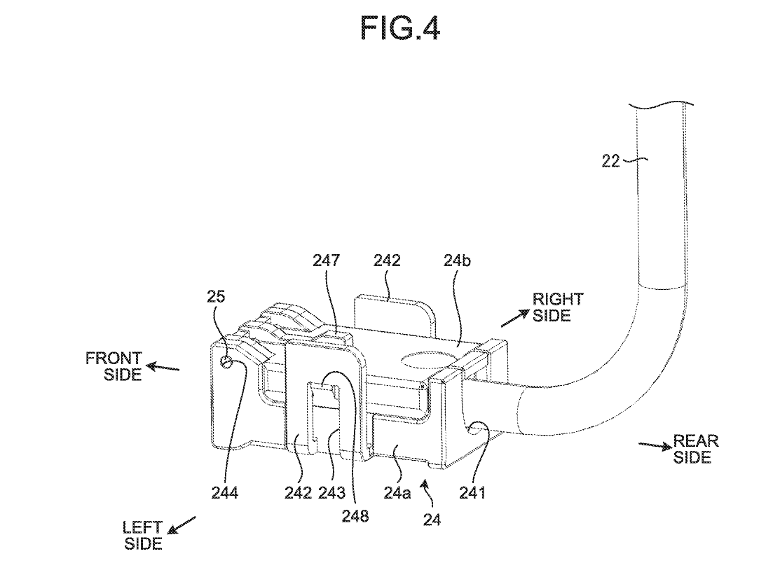

The plug 24 is attached to an end portion of the tube 22 connected to the BIB 21. FIG. 4 is a perspective view illustrating the plug 24 constituting the undiluted-solution storage unit 20. As illustrated in FIG. 4, the plug 24 is constituted of a plug main body 24a and a plug cover 24b.

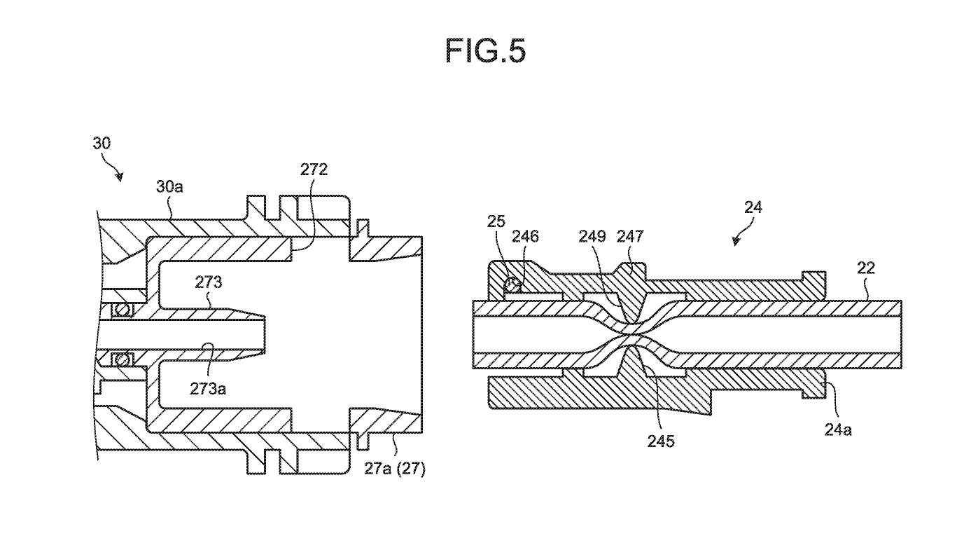

The plug main body 24a has a substantially rectangular parallelepiped shape in which an upper part and a front part are open, and a U-shaped groove 241 is formed on a rear part. At both left and right side portions of this plug main body 24a, locking pieces 242 that protrude upward are formed in left and right pair. In each of these left and right pair of the locking pieces 242, a locking groove 243 is formed. Furthermore, at upper front parts on the both left and right side portions of the plug main body 24a, a left and right pair of shaft supporting holes 244 is formed. Moreover, at a bottom portion of the plug main body 24a, a main body pinch 245 that protrudes upward is provided such that the longitudinal direction thereof coincides with a left-right direction as illustrated in FIG. 5.

The plug cover 24b is a substantially flat plate member, and a through hole 246 (refer to FIG. 5), an engaging protrusion 247, a locking protrusion 248, and a cover pinch 249 are formed therein. The through hole 246 is formed in a frontward portion so as to pierce through in a left-right direction. Through this through hole 246, a long rod-like plug pin 25 pierces, and both left and right end portions of this plug pin 25 are inserted into the shaft supporting holes 244 in the plug main body 24a. That is, the plug cover 24b is swingably supported by the plug main body 24a about a center axis of the plug pin 25.

The engaging protrusion 247 is formed so as to protrude upward from a top surface of the plug cover 24b. The locking protrusions 248 are formed so as to protrude outward (leftward, rightward) from both left and right end portions of the plug cover 24b.

The cover pinch 249 is a long member protruding downward that is formed on a bottom surface of the plug cover 24b such that the longitudinal direction there of coincides with the left-right direction. This cover pinch 249 is formed at a position opposing to the main body pinch 245 such that the plug cover 24b swings to come close to the plug main body 24a.

This plug 24 is attached to the end portion of the tube 22 in the following manner. First, the plug cover 24b is swung to be apart from the plug main body 24a, and the tube 22 is arranged between the plug main body 24a and the plug cover 24b such that an end surface of the tube 22 sticks out of the front of the plug main body 24a toward the front side, and a part thereof passes through the groove 241 on a rear surface.

Next, the plug cover 24b is swung to come close to the plug main body 24a. As the locking protrusion 248 of the plug cover 24b is inserted into the locking groove 243 in the locking piece 242 of the plug main body 24a to be engaged with the locking piece 242, the plug 24 can be attached to the end portion of the tube 22.

In this case, the cover pinch 249 of the plug cover 24b faces the main body pinch 245 of the plug main body 24a, and sandwiches a predetermined portion of the tube 22 together with the main body pinch 245, to close the tube 22. That is, the plug 24 is in a closing position.

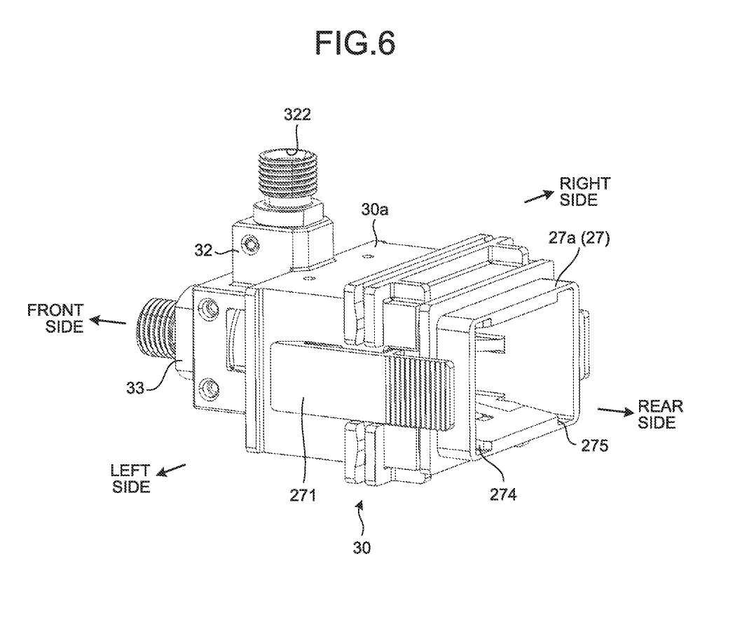

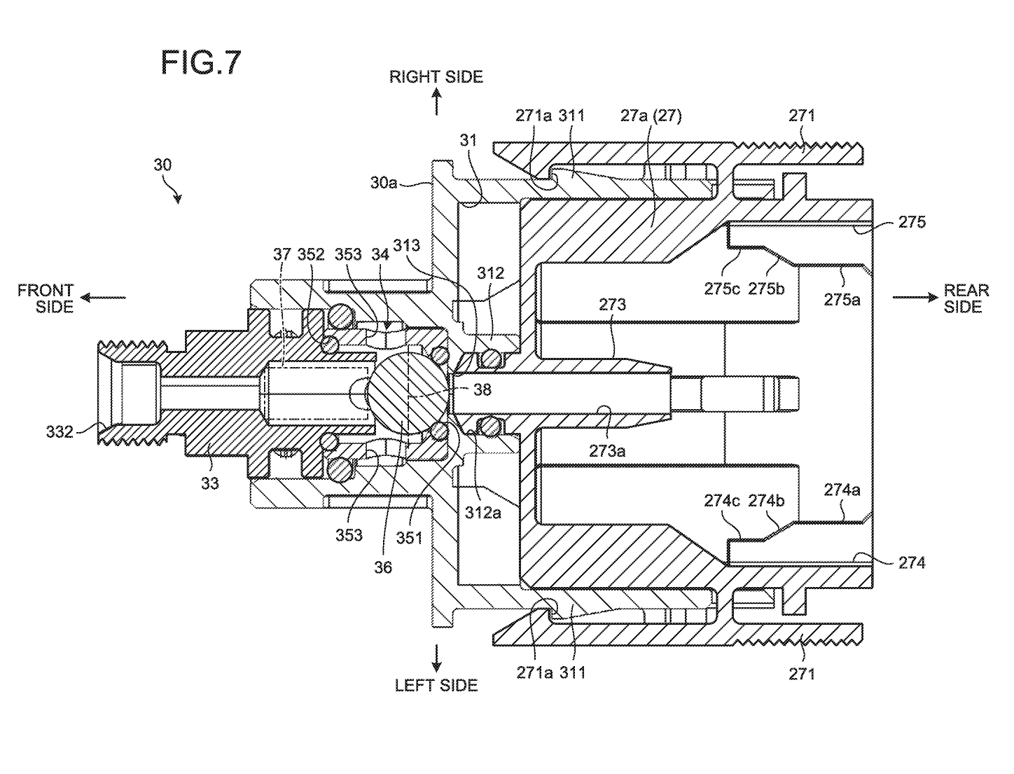

FIG. 6 is a perspective view illustrating the check valve structure 30 constituting the undiluted-solution storage unit 20, and FIG. 7 is a horizontal cross-sectional view of the check valve structure 30 illustrated in FIG. 6. The check valve structure 30 illustrated herein is connected to the mixing unit 50 through an undiluted-solution supplying tube 26, and includes a check-valve main body 30a as illustrated in FIG. 6 and FIG. 7.

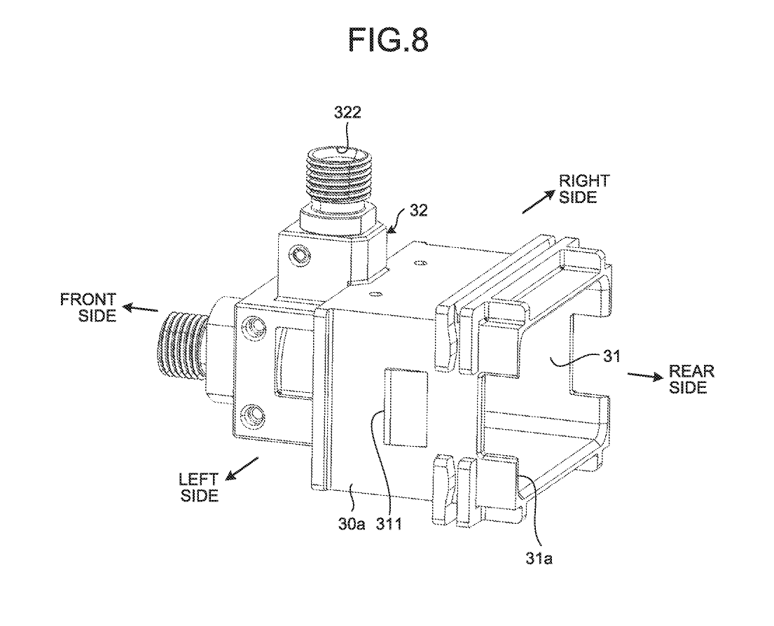

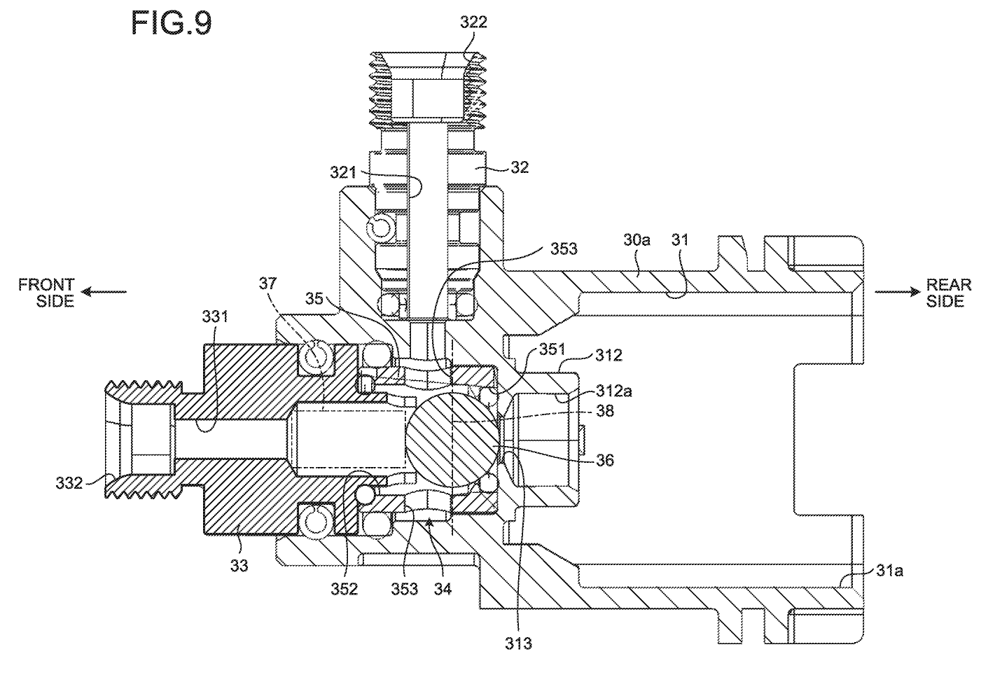

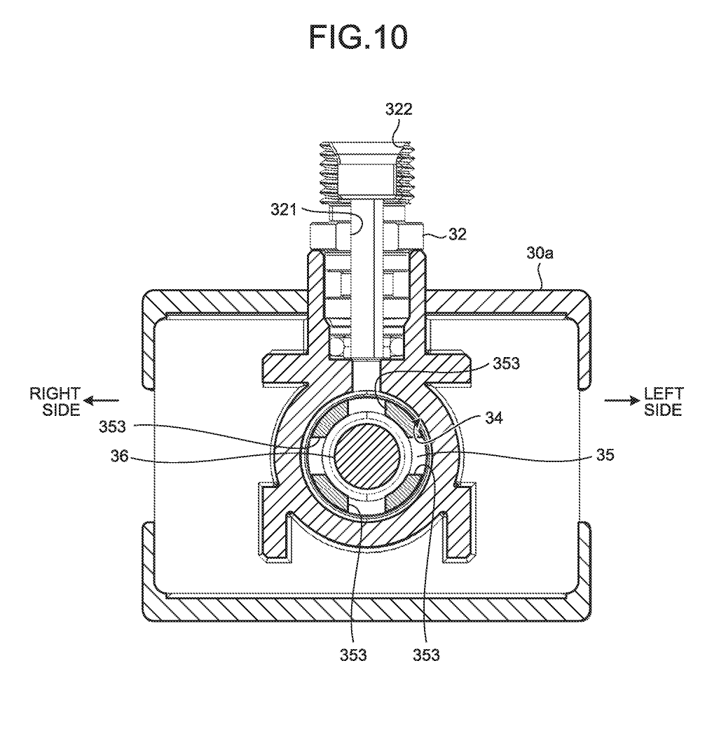

FIG. 8 to FIG. 10 illustrate the check-valve main body 30a constituting the check valve structure 30 illustrated in FIG. 6 and FIG. 7, and FIG. 8 is a perspective view, FIG. 9 is a vertical cross-sectional view of the check-valve main body 30a illustrated in FIG. 8 when viewed from the left side, and FIG. 10 is a vertical cross-sectional view of the check-valve main body 30a illustrated in FIG. 8 when viewed from the front side.

As illustrated in FIG. 8 to FIG. 10, the check-valve main body 30a includes a socket housing portion 31, a steam flow-in portion 32, an undiluted-solution flow-out portion 33, and a valve-member housing portion 34. The socket housing portion 31 is structured at a rear part of the check-valve main body 30a, and is a portion that allows insertion of a socket 27 (refer to FIG. 6 and FIG. 7) through a rear opening 31a, and that houses the socket 27.

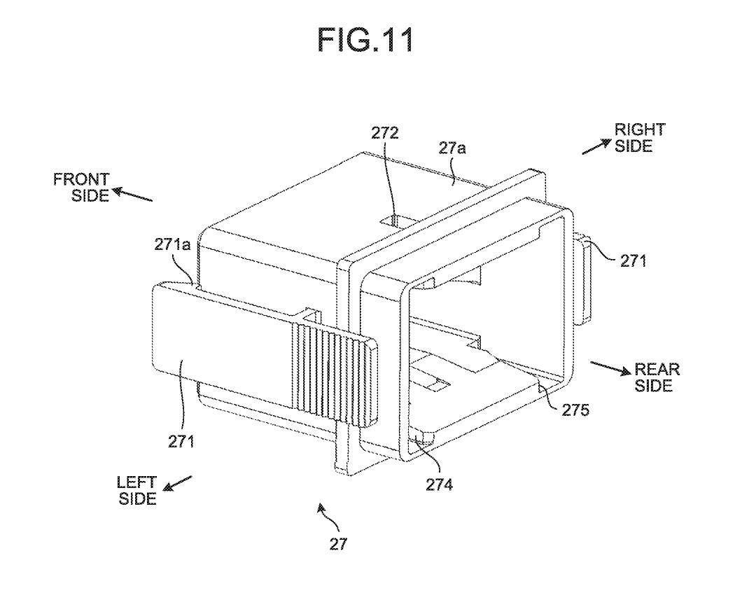

The socket 27 includes a socket main body 27a in a box shape that opens a rear side, as illustrated in FIG. 11. This socket 27 includes locking claw members 271, a restricting hole 272, an undiluted-solution guiding portion 273, and guide grooves 274, 275, formed in the socket main body 27a.

The locking claw member 271 is arranged on both left and right sides of the socket main body 27a, and the longitudinal direction thereof coincides with the front-rear direction. In a front part of these locking claw members 271, a locking claw 271a is formed. The restricting hole 272 is a rectangular hole that is formed in a top portion of the socket main body 27a.

The undiluted-solution guiding portion 273 is formed in a front part of the socket main body 27a so as to protrude frontward and rearward, and is a long cylindrical member, the longitudinal direction of which coincides with the front-rear direction. An outer diameter of this undiluted-solution guiding portion 273 is slightly larger than an internal diameter of the tube 22. In this undiluted-solution guiding portion 273, an undiluted-solution passage 273a that extends along the front-rear direction is formed.

The guide grooves 274, 275 are formed in left and right pair at a lower portion of the socket main body 27a on a rear side. In the guide groove 274 on the left side, a right end portion faces a left side portion of the socket main body 27a, and is constituted of a first right forward-extending portion 274a that extends toward a front, a right slant portion 274b that is connected to a front end portion of this first right forward-extending portion 274a and is gradually slanting toward a left side as it approaches the front, and a second right forward-extending portion 274c that extends toward the front in a continuous manner.

In the guide groove 275 on the right side, a left end portion faces a right side portion of the socket main body 27a, and is constituted of a first left forward-extending portion 275a that extends toward a front, a left slant portion 275b that is connected to a front end portion of this first left-extending portion 275a and is gradually slanting toward a right side as it approaches the front, and a second left forward-extending portion 275c that extends toward the front in a continuous manner.

As illustrated in FIG. 6 and FIG. 7, this socket 27 is housed in the socket housing portion 31 in such a manner that the front portion of the socket main body 27a enters the socket housing portion 31 through the rear opening 31a of the check-valve main body 30a, and that the locking claw 271a of the locking claw member 271 in the socket main body 27a is engaged with a locking protrusion 311 that is provided on both left and right sides of the check-valve main body 30a. The front end portion of the undiluted-solution guiding portion 273 of the socket 27 is inserted in a hollow portion 312a of a cylindrical portion 312 in the check-valve main body 30a. At a front end portion of the cylindrical portion 312, an undiluted-solution inlet 313 is formed, and the undiluted-solution passage 273a of the undiluted-solution guiding portion 273 faces the undiluted-solution inlet 313.

By thus housing the socket 27 in the socket housing portion 31, the check valve structure 30 is structured. Furthermore, as the check valve structure 30 is connected to the undiluted-solution supplying tube 26 as described above, the socket 27 is attached to piping to supply the undiluted milk solution.

The steam flow-in portion 32 is a portion connected to the second steam-supplying tube 13, and includes a steam flow-in passage 321. This steam flow-in passage 321 communicates with the second steam-supplying tube 13 through a steam inlet 322 that is provided in the check-valve main body 30a.

The undiluted-solution flow-out portion 33 is a portion connected to the undiluted-solution supplying tube 26, and includes an undiluted-solution flow-out passage 331. This undiluted-solution flow-out passage 331 communicates with the undiluted-solution supplying tube 26 through an undiluted-solution outlet 332 that is provided in the check-valve main body 30a.

The valve-member housing portion 34 is a room that is formed in a central area of the check-valve main body 30a, and communicates with the steam flow-in passage 321 and the undiluted-solution flow-out passage 331 described above, and communicates with the undiluted-solution passage 273a of the undiluted-solution guiding portion 273 in the socket 27 housed in the socket housing portion 31 through the undiluted-solution inlet 313. In this valve-member housing portion 34, a ball guide 35 is provided.

The ball guide 35 has a cylindrical shape, and includes a first opening 351 and a second opening 352. The first opening 351 is formed on a rear side and communicates with the undiluted-solution inlet 313 described above. The second opening 352 is formed on a front side, and communicates with the undiluted-solution outlet 332 by facing the undiluted-solution flow-out passage 331.

Inside the ball guide 35, a ball valve 36 is provided. The ball valve 36 is pushed backward all the time by a biasing member 37 of, for example, a spring or the like, and closes the first opening 351 of the ball guide 35, thereby closing the undiluted-solution inlet 313 in a normal state.

Moreover, in the ball guide 35, multiple ejection holes 353 are formed. These ejection holes 353 are formed on a peripheral surface of the ball guide 35 along the peripheral surface at predetermined intervals, and each communicates with the steam inlet 322 through the steam flow-in passage 321. Furthermore, these ejection holes 353 are formed on the ball valve 36 in a normal state, that is, the ball valve 36 in a state of closing the undiluted-solution inlet 313 by closing the first opening 351, at positions facing a surface on a side of the second opening 352 (front side) relative to a median plane (plane equally dividing the ball valve 36 symmetrically in a fore-aft direction) of the ball valve 36.

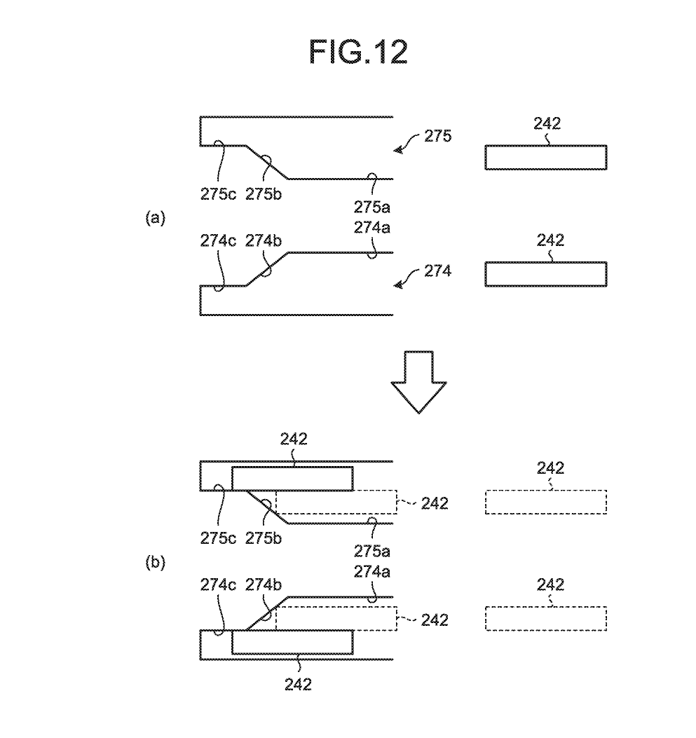

In the undiluted-solution storage unit 20 as described, the plug 24 and the socket 27 are connected in a following manner. As illustrated in FIG. 5, by bringing the plug 24 close to the socket 27 from the rear side thereof, the plug 24 is inserted into the socket main body 27a from the rear side. When the plug 24 enters the inside of the socket main body 27a, as illustrated in FIG. 12, a left and right pair of the locking pieces 242 enter the corresponding guide grooves 274, 275, respectively. As a result of the locking pieces 242 thus entering the guide grooves 274, 275, the locking piece 242 on the left side slides on the right slant portion 274b of the guide groove 274 on the left side, and then slides on the second right forward-extending portion 274c to displace toward the left, while the locking piece 242 on the right side slides on the left slant portion 275b of the guide groove 275 on the right side, and then slides on the second left forward-extending portion 275c to displace toward the right. As the locking piece 242 on the left side thus displaces toward the left, and the locking piece 242 on the right side thus displaces toward the right, the locking protrusion 248 inserted in the locking groove 243 of each of the locking pieces 242 is to be relatively apart from the locking groove 243, thereby bringing the plug cover 24b into a free state.

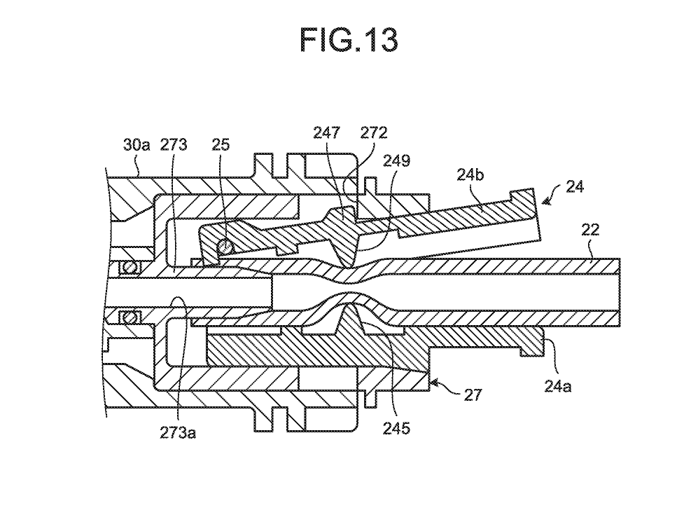

When the plug cover 24b is free, the plug cover 24b swings to be apart from the plug main body 24a by an elastic restoring force of the tube 22. Subsequently, as illustrated in FIG. 13, the engaging protrusion 247 of the plug cover 24b enters the restricting hole 272, and the plug 24 is thus brought into an engaged state with the socket 27, to be connected to the socket 27. At this time, a part of the undiluted-solution guiding portion 273 of the socket 27 enters the inside of the tube 22, and the undiluted-solution passage 273a of the undiluted-solution guiding portion 273 and the inside of the tube 22 are communicated with each other. Moreover, as the plug cover 24b swings, the cover pinch 249 is separated from the main body pinch 245, and the predetermined portion of the tube 22 that has been blocked by these is to be released. That is, by being into the engaged state with the socket 27, the plug 24 is brought into a releasing position.

The plug 24 can be separated from the socket 27 as follows. By swinging the plug cover 24b to bring close to the plug main body 24a, the engaging protrusion 247 is separated from the restricting hole 272. Subsequently, the plug 24 is moved backward while keeping the state in which the plug cover 24b is swung to be close to the plug main body 24a.

By thus moving the plug 24 backward, the left and right pair of the locking pieces 242 moves relatively backward in the corresponding guide grooves 274, 275, respectively. That is, the locking piece 242 on the left side displaces rightward by sliding on the right slant portion 274b of the guide groove 274 on the left side, and then on the first right forward-extending portion 274a, while the locking piece 242 on the right side displaces leftward by sliding on the left slant portion 275b of the guide groove 275 on the right side, and then on the first left-extending portion 275a. When the locking piece 242 on the left side displaces rightward, and the locking piece 242 on the right side displaces leftward, the locking protrusions 248 enter the locking grooves 243 of the respective locking pieces 242 to be engaged with the locking pieces 242, and the plug 24 is to be in the closing position described above.

As described above, the plug 24 and the socket 27 are detachable from each other, and the plug 24 is in the closing position when separated from the socket 27, and in the releasing position when connected to the socket 27. The socket 27 forcibly brings the plug 24 into the releasing position when connected to the plug 24. Moreover, the socket 27 allows the plug 24 to be separated therefrom when the plug 24 connected thereto turns into the closing position.

The air supplying unit 40 includes an air supplying tube 41. The air supplying tube 41 is connected to an air pump 42 at one end, and is connected to mixing unit 50 at the other end, and thus connects the air pump 42 and the mixing unit 50. The air pump 42 drives under a command given by the control unit, and pressurizes air and sends out the pressurized air through the air supplying tube 41 when driving.

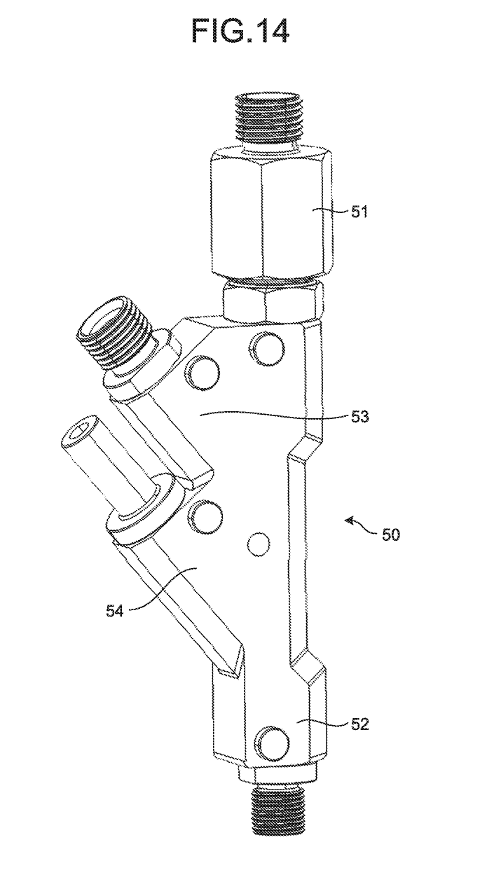

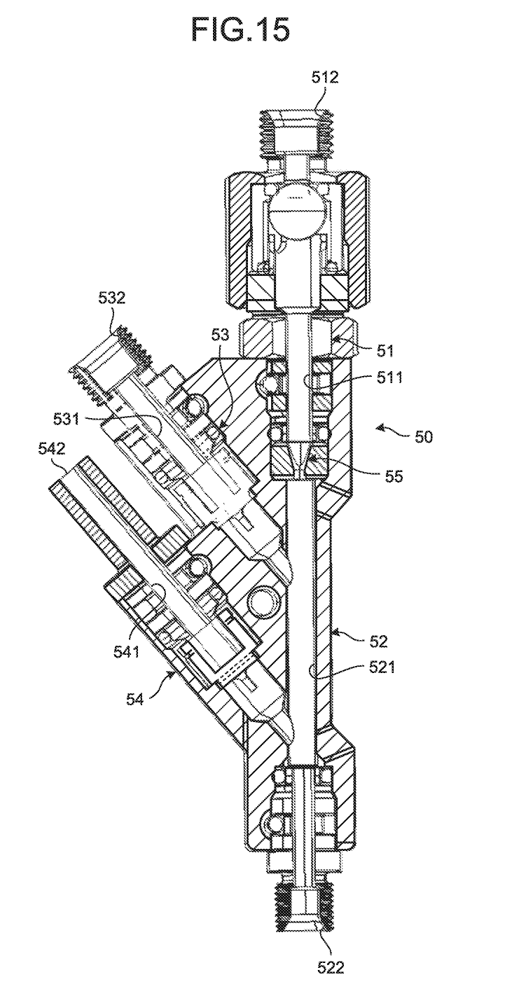

FIG. 14 and FIG. 15 illustrate the mixing unit 50 illustrated in FIG. 2, and FIG. 14 is a perspective view, and FIG. 15 is a cross sectional view. The mixing unit 50 illustrated herein is connected to the first steam-supplying tube 12, the undiluted-solution supplying tube 26, and the air supplying tube 41, and to a drink delivery tube 80 as well. The drink delivery tube 80 is connected to the mixing unit 50 at one end, and to the foaming unit 60 at the other end, and thus connects the mixing unit 50 and the foaming unit 60. This mixing unit 50 includes a steam inlet 51, a drink mixing portion 52, an undiluted-solution inlet 53, and an air inlet 54.

The steam inlet 51 is a portion connected to the first steam-supplying tube 12 described above, and includes a steam introducing path 511. This steam introducing path 511 communicates with the first steam-supplying tube 12 through the steam inlet 512.

The drink mixing unit 52 is a portion connected to the drink delivery tube 80 described above, and includes a mixing path 521. This mixing path 521 communicates with the steam introducing path 511 through an orifice member 55, and communicates with the drink delivery tube 80 through a drink outlet 522.

The undiluted-solution inlet 53 is a portion connected to the undiluted-solution supplying tube 26 described above, and includes an undiluted-solution introducing path 531. One end of this undiluted-solution introducing path 531 communicates with the undiluted-solution supplying tube 26 through an undiluted-solution inlet 532. Furthermore, the other end of the undiluted-solution introducing path 531 communicates with the mixing path 521.

The air inlet 54 is a portion connected to the air supplying tube 41 described above, and includes an air introducing path 541. One end of this air introducing path 541 communicates with the air supplying tube 41 through an air inlet 542. Furthermore, the other end of the air introducing path 541 is connected to the mixing path 521. Note that a position at which the air introducing path 541 communicates with the mixing path 521 is positioned on a downstream side relative to a position at which the undiluted-solution introducing path 531 communicates with the missing path 521.

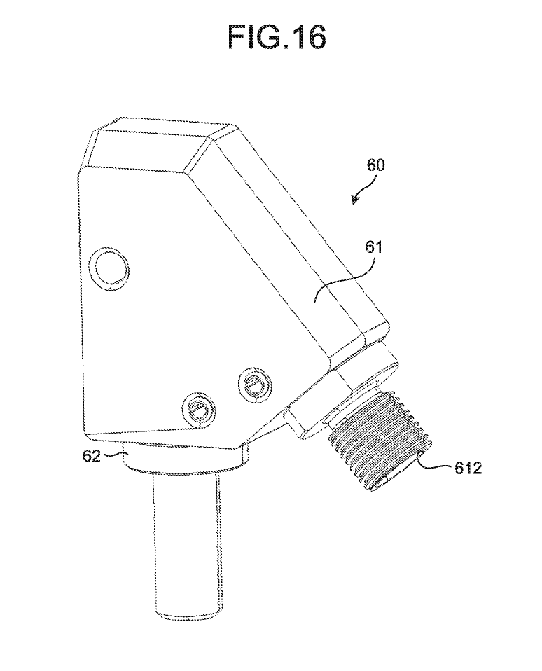

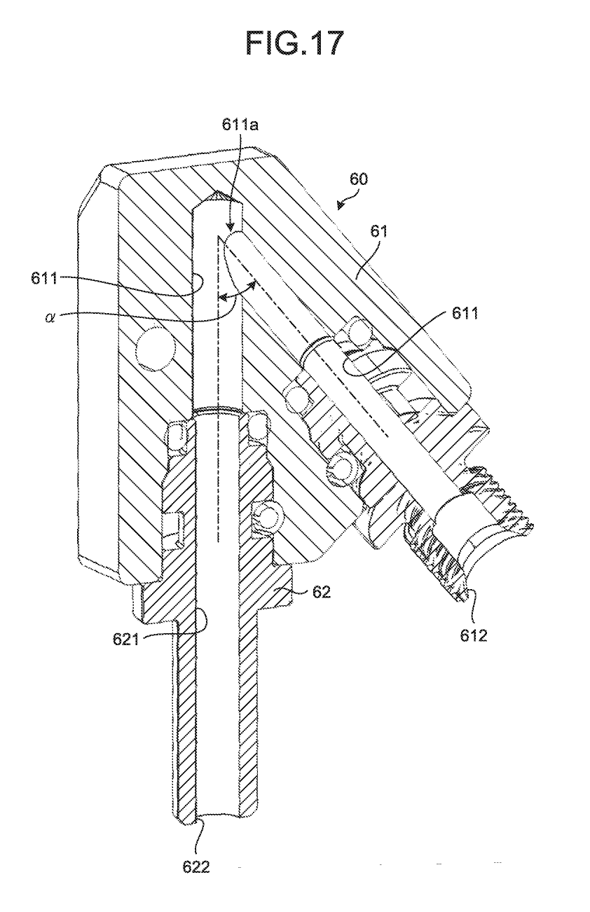

FIG. 16 and FIG. 17 illustrate the foaming unit 60 illustrated in FIG. 2, and FIG. 16 is a perspective view, and FIG. 17 is a cross sectional view. The foaming unit 60 illustrated herein is connected to the drink delivery tube 80, and to the nozzle unit 70 as well. This foaming unit 60 includes a drink inlet 61 and a drink outlet 62.

The drink inlet 61 is a portion connected to the drink delivery tube 80 described above, and includes a drink introducing path 611. This drink introducing path 611 communicates with the drink delivery tube 80 through a drink inlet 612. This drink introducing path 611 is structured to be bent in a middle thereof. It is preferable that an angle α between the drink introducing path 611 on an upstream side and the drink introducing path 611 on a downstream side to a bent portion 611a be an acute angle.

The drink outlet 62 is a portion connected to the nozzle unit 70, and includes a drink outputting path 621. This drink outputting path 621 communicates with the nozzle unit 70 through a drink outlet 622. Moreover, the drink outputting path 621 communicates with the drink introducing path 611.

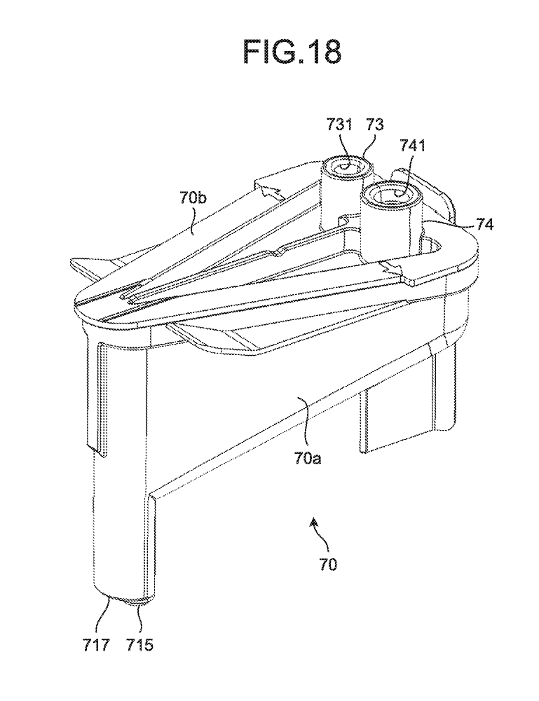

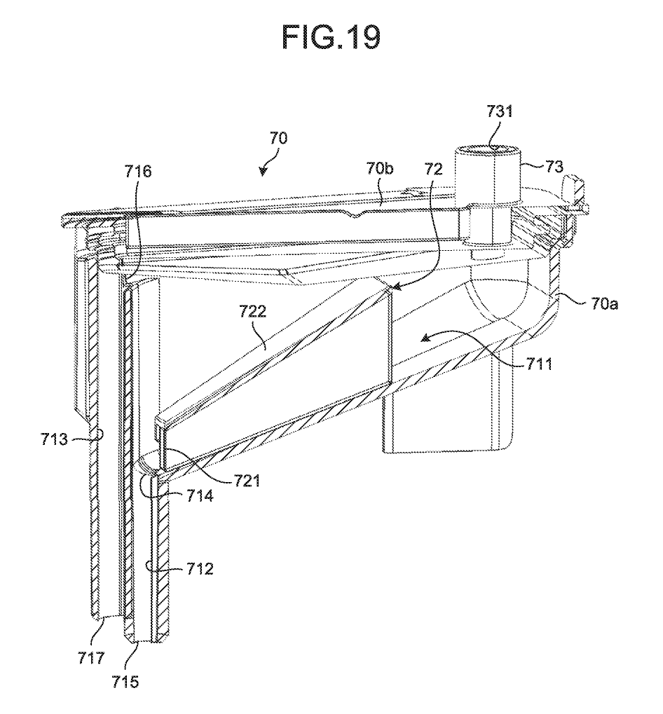

FIG. 18 and FIG. 19 illustrate the nozzle unit 70 illustrated in FIG. 2, and FIG. 18 is a perspective view, and FIG. 19 is a cross sectional view. The nozzle unit 70 illustrated herein is housed in the nozzle housing unit 700 provided on the front side of the dispenser main unit 1a as illustrated in FIG. 1, and includes a nozzle main body 70a and a nozzle cover 70b.

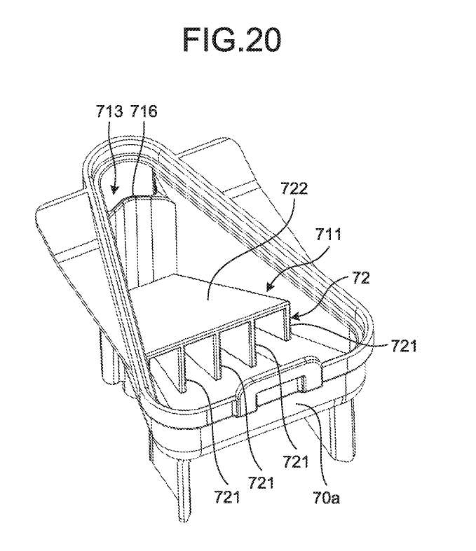

The nozzle main body 70a is a container in which a top portion is open as illustrated in FIG. 20 as well, and a bottom portion is gradually inclined downward as it approaches from a base portion to an end portion. In this nozzle main body 70a, a nozzle chamber 711, a discharge path 712, and a release path 713 are formed. The nozzle chamber 711 occupies most part of the nozzle main body 70a.

The discharge path 712 is formed at an end portion of the nozzle main body 70a, and extends downward. This discharge path 712 communicates with the nozzle chamber 711 through a discharge communication port 714, and communicates also with the outside through a discharge outlet 715. The discharge communication port 714 is provided at a lower portion of the nozzle chamber 711.

The release path 713 is formed at an end portion in the nozzle main body 70a, and extends downward, being adjacent to the discharge path 712. This release path 713 communicates with the nozzle chamber 711 through a release communication port 716, and communicates also with the outside through a release outlet 717 formed in the nozzle main body 70a. The release communication port 716 is provided at an upper portion of the nozzle chamber 711.

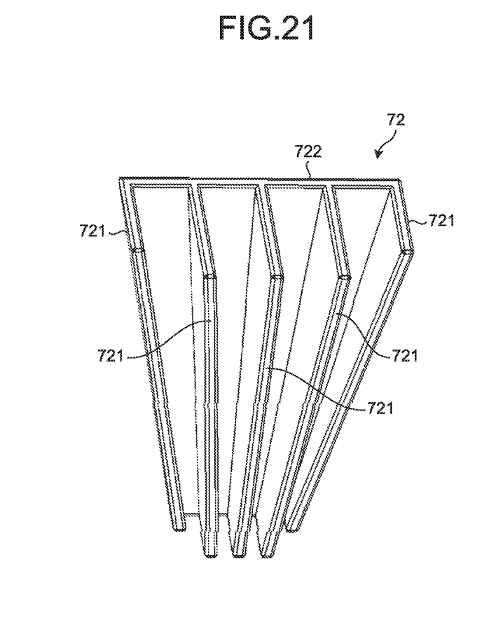

In the nozzle main body 70a, a drink guiding portion 72 is formed in the nozzle chamber 711. The drink guiding portion 72 is arranged at a lower portion of the nozzle chamber 711, that is at a bottom portion of the nozzle main body 70a, and is structured such that plural flat plate members 721 constituting the path are aligned, and an upper end portion of each of the flat plate members 721 is connected to a common support plate 722. As illustrated in FIG. 21, the flat plate members 721 are arranged such that a gap between the flat plate members 721 adjacent to each other becomes narrow as it approaches the discharge communication port 714 (discharge outlet 715). It lets drink to pass between the flat plate members 721 adjacent to each other, and then to pass through the discharge path 712.

The nozzle cover 70b is attached to the nozzle main body 70a so as to close the top portion of the nozzle main body 70a. This nozzle cover 70b includes a connecting tubular member 73 and a steam releasing portion 74. The connecting tubular member 73 is a cylindrical member that protrudes upward from the nozzle cover 70b. This connecting tubular member 73 includes a hollow portion 731 that communicates with the inside of the nozzle main body 70a formed therein, and is to connect to the foaming unit 60 by allowing a part of the drink outlet 62 of the foaming unit 60 to be inserted therein.

The steam releasing portion 74 is a cylindrical member that protrudes upward from the nozzle cover 70b, similar to the connecting tubular member 73. This steam releasing portion 74 includes a hollow portion 741 that communicates with the inside of the nozzle main body 70a formed therein, and is to release a part of steam that has been transmitted to the inside of the nozzle main body 70a.

In the drink dispenser configured as above, milk foam and steamed milk made by a following milk-foam pouring process and a steamed-milk pouring process stored in the control unit 90 can be supplied to the cup C.

(1) Milk-Foam Pouring Process

In this process, the first steam-supplying valve 14 is open, the tube pump 23 and the air pump 42 are activated, and the second steam-supplying valve 15 is closed by the control unit 90.

When the tube pump 23 is activated by a command from the control unit 90, in the undiluted-solution storage unit 20, a predetermined amount of the undiluted milk solution in the BIB 21 is pumped out. The undiluted milk solution pumped out of the BIB 21 passes through the tube 22, and then through the undiluted-solution passage 273a of the undiluted-solution guiding portion 273 of the socket 27, to reach the undiluted-solution inlet 313. The undiluted-solution inlet 313 is closed by the ball valve 36, and the ball valve 36 recedes toward the front side against the biasing force of the biasing member 37 by pressure of the undiluted milk solution pumped from the BIB 21. Thus, the undiluted-solution inlet 313 and the first opening 351 are released, and the undiluted milk solution reaches the undiluted-solution flow-out passage 331 through the undiluted-solution inlet 313 and the first opening 351, and then passes through this undiluted-solution flow-out passage 331 and through the undiluted-solution supplying tube 26. The undiluted milk solution passing through this undiluted-solution supplying tube 26 reaches the undiluted-solution introducing path 531 of the mixing unit 50.

As the first steam-supplying valve 14 is open, pressurized steam generated in the steam tank 11 passes through the first steam-supplying tube 12 to reach the steam introducing path 511 of the mixing unit 50. Moreover, by driving the air pump 42, compressed air passes through the air supplying tube 41 to reach the air introducing path 541 of the mixing unit 50.

In the mixing unit 50, as the pressurized steam that has passed through the steam introducing path 511 passes through the mixing path 521 in a state in which pressure is reduced and the flow speed is increased by passing through the orifice member 55, the undiluted milk solution of the undiluted-solution introducing path 531 reaches the mixing path 521 by the venturi effect, and is heated and diluted by the pressurized steam.

Furthermore, in the mixing unit 50, as the compressed air in the air introducing path 541 enters the mixing path 521 to be mixed with the undiluted milk solution by the pressurized steam, and drink with milk is to be in a foamed state by the compressed air. Milk with foam thus made by the mixing unit 50 passes through the drink delivery tube 80 to reach the drink introducing path 611 of the foaming unit 60.

In the foaming unit 60, milk with foam passing through the drink introducing path 611 changes its passage at the bent portion 611a of the drink introducing path 611, and the milk with foam becomes milk foam with the increased amount of foam by hitting on a path wall at the bent portion 611a. The milk foam thus foamed passes through the drink outputting path 621 to be sent to the nozzle unit 70.

The foamed milk foam sent to the nozzle unit 70 is temporarily stored in the nozzle chamber 711, and then passes between the flat plate members 721 of the drink guiding portion 72. As the flat plate members 721 are aligned in a manner that gaps therebetween gradually narrows as it comes closer to the discharge outlet 715, large bubbles cannot pass through between the flat plate members 721 and stay therebetween, and only fine bubbles pass through between the flat plate members 721.

Furthermore, as a part of steam and the like is released from the steam releasing portion 74 arranged at the nozzle cover 70b and the release path 713, the milk foam temporarily stored in the nozzle chamber 711 pass through the discharge path 712 after passing through between the flat plate members 721, to be discharged into the cup C from the discharge outlet 715. Thus, fine quality milk foam is supplied.

After supplying a predetermined amount of milk foam as described above, the second steam-supplying valve 15 is open, and the tube pump 23 is stopped by the control unit 90. Note that the air pump 42 is kept driving, and the first steam-supplying valve 14 is also open.

When the second steam-supplying valve 15 is open, pressurized steam generated in the steam tank 11 passes through the second steam-supplying tube 13 and reaches the second steam-supplying tube 13 of the check valve structure 30. In the check valve structure 30, because the undiluted milk solution is not pumped from the BIB 21 as the tube pump 23 has stopped driving, the undiluted-solution inlet 313 is closed by the ball valve 36.

In the check valve structure 30, the pressurized steam in the steam flow-in passage 321 reaches the valve-member housing portion 34, and passes around the ball guide 35 to be ejected to a surface of the ball valve 36 from the ejection holes 353. The pressurized steam ejected to the surface of the ball valve 36 passes through the undiluted-solution supplying tube 26 together with the undiluted milk solution adhering on the surface of the ball valve 36 through the undiluted-solution flow-out passage 331, and reaches the undiluted-solution introducing path 531 of the mixing unit 50.

The pressurized steam (pressurized steam supplied from the check valve structure 30 together with the undiluted milk solution) in the undiluted-solution introducing path 531 is mixed with pressurized steam supplied to the mixing unit 50 through the first steam-supplying tube 12 and compressed air supplied to the mixing unit 50 through the air supplying tube 41, and passes the foaming unit 60 together with milk adhering on the path.

The pressurized steam and the like that have passed the foaming unit 60 as described make milk flow with the foam stored in the nozzle chamber 711 of the nozzle unit 70 to be supplied to the cup C from the discharge outlet 715.

Thus, milk remaining in each portion from the check valve structure 30 to the discharge outlet 715 of the nozzle unit 70 can also be supplied to the cup C, and these paths can be cleaned.

Thereafter, the control unit 90 closes the first steam-supplying valve 14 and the second steam-supplying valve 15, and stops the air pump 42, and thus, the milk-foam pouring process, that is, the milk-foam pouring process in which steam, undiluted milk solution, and compressed air are supplied to a mixing means (mixing unit 50), foamed milk made by foaming by the mixing means (mixing unit 50) is supplied to a foaming means (foaming unit 60), and milk foam made by the foaming means (foaming unit 60) is poured through a nozzle means (nozzle unit 70) is ended.

(2) Steamed-Milk Pouring Process

In this process, the first steam-supplying valve 14 is open and the tube pump 23 is activated by the control unit 90, and the second steam-supplying valve 15 is open and the air pump 42 is stopped.

When the tube pump 23 is activated by a command of the control unit 90, in the undiluted-solution storage unit 20, a predetermined amount of undiluted milk solution in the BIB 21 is pumped out. The undiluted milk solution pumped out from the BIB 21 passes through the tube 22, and then passes through the undiluted-solution passage 273a of the undiluted-solution guiding portion 273 in the socket 27 to reach the undiluted-solution inlet 313. Although the undiluted-solution inlet 313 is closed by the ball valve 36, the ball valve 36 recedes toward the front side against the biasing force of the biasing member 37 by pressure of the undiluted milk solution pumped from the BIB 21. Thus, the undiluted-solution inlet 313 and the first opening 351 are released, and the undiluted milk solution reaches the undiluted-solution flow-out passage 331 through the undiluted-solution inlet 313 and the first opening 351, and then passes through this undiluted-solution flow-out passage 331 and through the undiluted-solution supplying tube 26. The undiluted milk solution passing through this undiluted-solution supplying tube 26 reaches the undiluted-solution introducing path 531 of the mixing unit 50.

As the first steam-supplying valve 14 is open, pressurized steam generated in the steam tank 11 passes through the first steam-supplying tube 12 to reach the steam introducing path 511 of the mixing unit 50.

In the mixing unit 50, as the pressurized steam that has passed through the steam introducing path 511 passes through the mixing path 521 in a state in which pressure is reduced and the flow speed is increased by passing through the orifice member 55, the undiluted milk solution of the undiluted-solution introducing path 531 reaches the mixing path 521 by the Venturi effect, and is heated and mixed with steam by the pressurized steam to be steamed milk. In this case, because the air pump 42 is stopped and compressed air is not to enter from the air introducing path 541, that is, because the liquid steamed milk made by mixing with steam is not to be mixed with air, the liquid steamed milk is not to be bubbled. The steamed milk thus made by the mixing unit 50 passes through the drink delivery tube 80 to reach the drink introducing path 611 of the foaming unit 60.

In the foaming unit 60, although the steamed milk passing through the drink introducing path 611 changes its passage at the bent portion 611a of the drink introducing path 611 and hits the path wall at the bent portion 611a, foam is not created as the steamed milk does not contain bubbles. Specifically, because the drink introducing path 611 and the bent portion 611a are filled with steamed milk, and the steamed milk does not contain air, bubbles are not generated. The steamed milk then passes through the drink outputting path 621 to be sent to the nozzle unit 70.

The steamed milk sent to the nozzle unit 70 is temporarily stored in the nozzle chamber 711, and then passes between the flat plate members 721 of the drink guiding portion 72. As a part of steam and the like is released from the steam releasing portion 74 arranged at the nozzle cover 70b, and the release path 713, the steamed milk temporarily stored in the nozzle chamber 711 pass through the discharge path 712 after passing through between the flat plate members 721 to be discharged into the cup C from the discharge outlet 715.

After supplying a predetermined amount of steamed milk as described above, the second steam-supplying valve 15 is open, and the air pump 42 is activated by the control unit 90. Note that the first steam-supplying valve 14 stays open.

When the second steam-supplying valve 15 is open, pressurized steam generated in the steam tank 11 passes through the second steam-supplying tube 13 to reach the steam flow-in passage 321 of the check valve structure 30. In the check valve structure 30, because the undiluted milk solution is not pumped from the BIB 21 as the tube pump 23 has stopped driving, the undiluted-solution inlet 313 is closed by the ball valve 36. In the check valve structure 30, the pressurized steam in the steam flow-in passage 321 reaches the valve-member housing portion 34, and passes around the ball guide 35 to be ejected to the surface of the ball valve 36 from the ejection holes 353. The pressurized steam ejected to the surface of the ball valve 36 passes through the undiluted-solution supplying tube 26 together with the undiluted milk solution adhering on the surface of the ball valve 36 through the undiluted-solution flow-out passage 331, and reaches the undiluted-solution introducing path 531 of the mixing unit 50. The pressurized steam (pressurized steam supplied from the check valve structure 30 together with the undiluted milk solution) in the undiluted-solution introducing path 531 is mixed with pressurized steam supplied to the mixing unit 50 through the first steam-supplying tube 12 and compressed air supplied to the mixing unit 50 through the air supplying tube 41, and passes the foaming unit 60 together with milk adhering on the path.

The pressurized steam and the like that have passed the foaming unit 60 as described make milk flow with the foam stored in the nozzle chamber 711 of the nozzle unit 70 to be supplied to the cup C from the discharge outlet 715. Thus, milk remaining in each portion from the check valve structure 30 to the discharge outlet 715 of the nozzle unit 70 can also be supplied to the cup C, and these paths can be cleaned.

Thereafter, the control unit 90 opens the first steam-supplying valve 14 and the second steam-supplying valve 15, and stops the air pump 42, and thus, the steamed-milk pouring process, that is, the steamed-milk pouring process in which steam and undiluted milk solution are supplied to a mixing means (mixing unit 50), liquid steamed milk made by the mixing means (mixing unit 50) is poured through a nozzle means (nozzle unit 70) is ended.

In the drink dispenser 1 (refer to FIG. 1) thus configured, when a drink with milk (hot milk) is selected by the drink selection button 1c provided at the front cover 1b, the control unit 90 performs the pouring process of milk foam, and then performs the pouring process of liquid steamed milk. Thus, in the cup C, milk foam that is poured first is accumulated as a layer, and the liquid steamed milk to be poured subsequently is to be poured on the milk foam accumulated as a layer. Therefore, at the time when the liquid steamed milk is poured into the cup C, as the milk foam has already been accumulated in the cup C, splash of the liquid steamed milk caused by directly colliding with a bottom surface of the cup C can be suppressed. Moreover, even if the liquid steamed milk collides with the bottom surface of the cup C passing through the layer of milk foam and splashes, as it is covered by the milk foam, it is suppressed to cause bubbles taking air therein, and even if bubbles are generated, it can, at least, avoid generation a lump of bubbles. The liquid steamed milk poured on the layer of milk foam passes through the milk foam and goes under the milk foam. Therefore, the surface of hot milk in the cup C is covered with fine quality milk foam, thereby enabling to maintain the favorable drink quality.

Although the drink dispenser 1 described above has been explained as one providing hot milk, it can also provide drinks with milk such as cappuccino and café au lait by adding a known coffee unit. In this case, the coffee unit grinds a predetermined amount of coffee beans taken out of a coffee bean canister to make ground beans and supplies it to a pressure-proof extraction chamber, makes hot water at high heat pressurized by a pump pass through the ground beans that is compressed by applying pressure in the extraction chamber to extract thick coffee solution, and pours this coffee solution to the cup C through a coffee nozzle. When cappuccino is selected, after pouring milk foam and then steamed milk, coffee solution is poured into the cup C, and when café au lait is selected, after pouring steamed milk, coffee solution is poured into the cup C from the coffee unit.

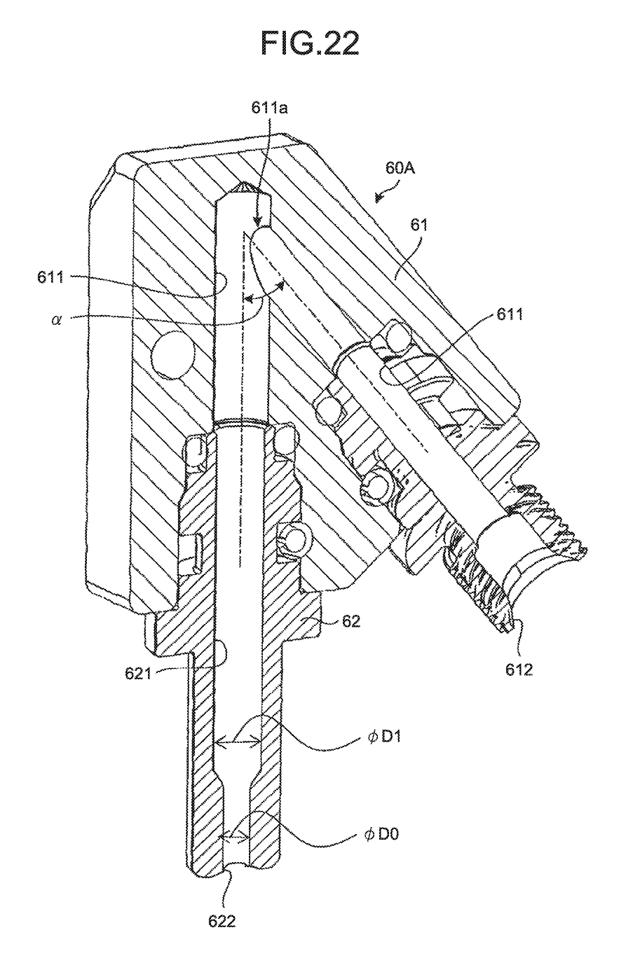

Next, FIG. 22 is a perspective view illustrating a modification of the foaming unit 60. A foaming unit 60A illustrated herein includes the drink inlet 61 connected to the drink delivery tube 80 and the drink outlet 62 connected to the nozzle unit 70. Similar to the foaming unit 60 illustrated in FIG. 16 and FIG. 17 and the same symbols are assigned to explain the same parts, and the repeated explanation thereof is omitted.

A point that the foaming unit 60A illustrated in FIG. 22 differs from the foaming unit 60 illustrated in FIG. 16 and FIG. 17 is that the thickness of the drink outlet (discharge outlet) 622 that is an end portion of the drink outlet 62 is made thicker than the thickness of the drink outputting path 621 on an upstream side to the drink outlet (discharge outlet) 622. That is, a tube diameter φD0 of the drink outlet (discharge outlet) 622 is arranged to be small compared to a tube diameter φD1 of the drink outputting path 621 on an upstream side relative to the drink outlet (discharge outlet) 622. This drink outlet (discharge outlet) 622 enters the inside (nozzle chamber 711) of the nozzle main body 70a to be a discharge outlet of steamed milk or milk foam, and links the foaming unit 60 and the nozzle unit 70.

By thus making the tube diameter φD0 of the drink outlet (discharge outlet) 622 that is an end portion of the drink outlet 62 of the foaming unit 60A small compared to the tube diameter φD1 of the drink outputting path 621 that is positioned upstream to the drink outlet (discharge outlet) 622, it is possible to avoid generation of unnecessary bubbles in steamed milk or milk foam that is discharged to the inside (nozzle chamber 711) of the nozzle main body 70a. That is, while when the tube diameter of the drink outlet (discharge outlet) 622 is large (tube diameter φD0 or larger), an area of steamed milk or milk foam exposed to air is large and unnecessary bubbles are generated taking in air, when the tube diameter φD0 of the drink outlet (discharge outlet) 622 is smaller than φD1, a rear of the steamed milk or the milk foam exposed to air is small, and generation of unnecessary bubbles can be suppressed.

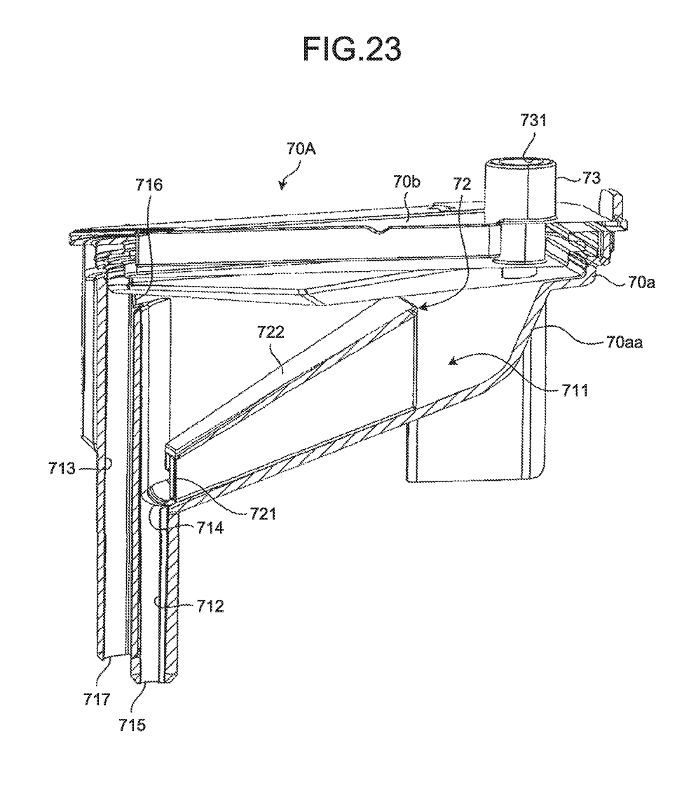

Next, FIG. 23 is a cross-sectional view illustrating a modification of the nozzle unit 70. In a nozzle unit 70A illustrated herein, similar to the nozzle unit 70 illustrated in FIG. 18 to FIG. 20, a bottom portion is gradually inclined downward as it approaches from a base portion to an end portion, and in the connecting tubular member 73 provided in the nozzle cover 70b, the hollow portion 731 that communicates with the inside of the nozzle main body 70a is formed, and allows insertion of the drink outlet (discharge outlet) 622 that is an end portion of the drink outlet 62 of the foaming unit 60A. The same symbols are assigned to the same parts in the nozzle unit 70 illustrated in FIG. 18 to FIG. 20, and the repeated explanation is omitted.

A point that the nozzle unit 70A illustrated in FIG. 23 differs from the nozzle unit 70 illustrated in FIG. 18 to FIG. 20 is a point that an inclined surface 70aa is arranged at a bottom of the nozzle main body 70a on a base portion side. Specifically, it is a point that the inclined surface 70aa corresponds to a portion facing the drink outlet (discharge outlet) 622 that is the end portion of the drink outlet 62 of the foaming unit 60A, and an angle at which steamed milk or milk foam discharged from the drink outlet (discharge outlet) 622 is at least an acute angle at least smaller than 45 degrees.

By thus providing the inclined surface 70aa at a portion facing the drink outlet (discharge outlet) 622 that is the end portion of the drink outlet 62 of the foaming unit 60A to make a colliding angle of steam milk or milk foam discharged from the drink outlet 62 an acute angle at least smaller than 45 degrees, it is possible to suppress generation of unnecessary bubbles by collision of the steamed milk or the milk foam. That is, while when an angle of a portion with which steamed milk or milk foam discharged from the drink outlet (discharge outlet) 622 collides is a right angle as in the nozzle unit 70 illustrated in FIG. 18 to FIG. 20, unnecessary bubbles are generated by collision of the steamed milk or milk foam, by arranging such that an angle at which steamed milk or milk foam discharged from the drink outlet (discharge outlet) 622 is an acute angle at least smaller than 45 degrees, generation of unnecessary bubbles caused by collision of the steamed milk or milk foam can be suppressed.

As described above, the drink dispenser according to this embodiment includes an undiluted-solution storage means (undiluted-solution storage unit 20) that stores undiluted milk solution at cool temperature, a steam supplying means (steam supplying unit 10) that supplies heated steam, an air supplying means (air supplying unit 40) that supplies compressed air, a mixing means (mixing unit 50) that is structured to be supplied with steam from the steam supplying means (steam supplying unit 10), undiluted milk solution from the undiluted-solution storage means (undiluted-solution storage unit 20), and compressed air from the air supplying means (air supplying unit 40), and that makes, when steam and undiluted milk solution are supplied, warmed liquid steamed milk by mixing the steam and the undiluted milk solution, and makes, when steam, undiluted milk solution, and compressed air are supplied, milk with foam warmed by the steam and foamed with the compressed air by mixing the steam, the undiluted milk solution, and the compressed air, a nozzle means (nozzle unit 70) from which the liquid steamed milk made and warmed by the mixing means (mixing unit 50) is poured, a foaming means (foaming unit 60) that increases foams in the milk with foam supplied from the mixing means (mixing unit 50) to make milk foam, a nozzle means (nozzle unit 70) from which the milk foam made by the foaming means (foaming unit 60) is poured, and a control means (control unit 90) that has a pouring process of liquid steamed milk in which steam and undiluted milk solution are supplied to the mixing means (mixing unit 50), and liquid steamed milk made by the mixing means (mixing unit 50) is poured through the nozzle means (nozzle unit 70), and a pouring process of milk foam in which steam, undiluted milk solution, and compressed air are supplied to the mixing means (mixing unit 50), milk with foam that is made and foamed by the mixing means (mixing unit 50) is supplied to the foaming means (foaming unit 60), and milk foam that is made by the foaming means (foaming unit 60) is poured through the nozzle means (nozzle unit 70), and that performs the pouring process of liquid steamed milk and the pouring process of milk foam to pour drink with milk into a drink container (cup C) when a drink with milk is selected. the control means (control unit 90) performs the pouring process of milk foam and then the pouring process of steamed milk when a drink with milk is selected, thereby suppressing splash of liquid steamed milk by directly colliding with a drink container with a layer of milk foam as the milk foam is accumulated in the drink container as a layer at the time when liquid steamed milk is poured into the drink container. Moreover, even if liquid steamed milk passes through a layer of milk foam to collide with a drink container and splashes, as it is covered by the milk foam, it is suppressed to cause bubbles taking air therein, and even if bubbles are generated, at least, generation a group of lumps of bubbles can be avoided. The liquid steamed milk poured on the layer of milk foam passes through the milk foam and goes under the milk foam. Therefore, the surface of hot milk in the cup C is covered with fine quality milk foam, thereby enabling to maintain the favorable drink quality.

In a method of pouring drink with milk according to an embodiment of the present disclosure, it is a method of pouring drink with milk for providing drink with milk that includes milk foam and steamed milk and that is topped with milk foam on a top layer in a drink container, the drink with milk made by pouring foamy milk foam that is made by mixing heated steam, undiluted milk solution, and air, and liquid steamed milk made by mixing heated steam and undiluted milk solution in the drink container, and after pouring the milk foam, the liquid steamed milk is poured into the drink container. Thus, at the time when the liquid steamed milk is poured into the drink container, the milk foam has already been accumulated as a layer in the drink container, splash of the liquid steamed milk caused by directly colliding with the drink container can be suppressed by this layer of milk foam. Moreover, even if the liquid steamed milk collides with the drink container passing through the layer of milk foam and splashes, as it is covered by the milk foam, it is suppressed to cause bubbles taking air therein and, at least, it can avoid generation a lump of bubbles. The liquid steamed milk poured on the layer of milk foam passes through the milk foam and goes under the milk foam. Therefore, the surface of hot milk in the drink container is covered with fine quality milk foam, thereby enabling to maintain the favorable drink quality.

Moreover, in a drink dispenser according to an embodiment of the present disclosure, in a drink dispenser that includes an undiluted-solution storage unit that stores undiluted milk solution at cool temperature; a steam supplying unit that supplies heated steam; an air supplying unit that supplies compressed air; a mixing unit that is structured to be supplied with steam from the steam supplying unit, undiluted milk solution from the undiluted-solution storage unit, and compressed air from the air supplying unit, and that makes, when steam and undiluted milk solution are supplied, warmed liquid steamed milk by mixing the steam and the undiluted milk solution, and makes, when steam, undiluted milk solution, and compressed air are supplied, milk with foam warmed by the steam and foamed with the compressed air by mixing the steam, the undiluted milk solution, and the compressed air; a nozzle unit that pours the warmed liquid steamed milk that is made by the mixing unit; a foaming unit that increases foam in the milk with foam supplied from the mixing unit to make milk foam; a nozzle unit that pours the milk foam made by the foaming unit; and a control unit that has a pouring process of liquid steamed milk in which steam and undiluted milk solution are supplied to the mixing unit, and liquid steamed milk made by the mixing unit is poured through the nozzle unit, and a pouring process of milk foam in which steam, undiluted milk solution, and compressed air are supplied to the mixing unit, milk with foam that is made and foamed by the mixing unit is supplied to the foaming unit, and milk foam that is made by the foaming unit is poured through the nozzle unit, and that performs the pouring process of liquid steamed milk and the pouring process of milk foam to pour drink with milk into a drink container when a drink with milk is selected, the control unit performs the pouring process of milk foam and then the pouring process of steamed milk when a drink with milk is selected, thereby obtaining a similar effect to the disclosure according to claim 1. That is, at the time when the liquid steamed milk is poured into the drink container, the milk foam has already been accumulated as a layer in the drink container, splash of the liquid steamed milk caused by directly colliding with the drink container can be suppressed by this layer of milk foam. Moreover, even if the liquid steamed milk collides with the drink container passing through the layer of milk foam and splashes, as it is covered by the milk foam, it is suppressed to cause bubbles taking air therein and, at least, it can avoid generation a lump of bubbles. The liquid steamed milk poured on the layer of milk foam passes through the milk foam and goes under the milk foam. Therefore, the surface of hot milk in the drink container is covered with fine quality milk foam, thereby enabling to maintain the favorable drink quality.

Although in the embodiment described above, one that pours steamed milk made by the mixing unit 50 is poured into the cup C from the nozzle 70 through the foaming unit 60 that makes milk foam into the cup C has been explained, by providing a switch valve at the drink delivery tube 80, steamed milk can be poured without passing through the foaming unit 60 from a branch tube that branches from the drink delivery tube 80. Accordingly, the present disclosure is not limited to the embodiment.

1. A method of pouring drink with milk, the method comprising:
pouring milk foam made by mixing heated steam, undiluted milk solution, and air into a drink container; and
pouring liquid steam milk made by mixing heated steam and undiluted milk solution into the drink container after pouring the milk foam so as to provide drink with milk including the milk foam and the steamed milk, the drink being topped with the milk foam on a top layer in the drink container.

2. A drink dispenser comprising:
an undiluted-solution storage unit that stores undiluted milk solution at cool temperature;
a steam supplying unit that supplies heated steam;
an air supplying unit that supplies compressed air;
a mixing unit that is structured to be supplied with steam from the steam supplying unit, undiluted milk solution from the undiluted-solution storage unit, and compressed air from the air supplying unit, and that makes, when steam and undiluted milk solution are supplied, warmed liquid steamed milk by mixing the steam and the undiluted milk solution, and makes, when steam, undiluted milk solution, and compressed air are supplied, milk with foam warmed by the steam and foamed with the compressed air by mixing the steam, the undiluted milk solution, and the compressed air;
a foaming unit that increases foam in the milk with foam supplied from the mixing unit to make milk foam;
a nozzle unit that pours the warmed liquid steamed milk that is made by the mixing unit and the milk foam made by the foaming unit; and
a control unit that has a liquid steamed milk pouring process of pouring liquid steamed milk in which steam and undiluted milk solution are supplied to the mixing unit, and liquid steamed milk made by the mixing unit is poured through the nozzle unit, and a milk foam pouring process of pouring milk foam in which steam, undiluted milk solution, and compressed air are supplied to the mixing unit, milk with foam that is made and foamed by the mixing unit is supplied to the foaming unit, and milk foam that is made by the foaming unit is poured through the nozzle unit, and that performs the liquid steamed milk pouring process and the milk foam pouring process to pour drink with milk into a drink container when a drink with milk is selected,
wherein the control unit performs the milk foam pouring process and then the liquid steamed milk pouring process when a drink with milk is selected.

3. The drink dispenser according to claim 2, wherein
the nozzle unit is structured as a container to temporarily store any one of the warmed liquid steamed milk and the milk foam supplied from any one of the mixing unit and the foaming unit, and to remove steam,
a bottom portion of the container is formed so as to be gradually inclined downward as approaching to an end apart from a base that is a portion at which any one of the steamed milk and the milk foam is supplied, and a nozzle part is formed at the end from which any one of the liquid steamed milk and the milk foam is poured, and
an angle of a wall with which any one of the liquid steamed milk and the milk foam collides in the container is formed as an acute angle.

4. The drink dispenser according to claim 3, wherein
a diameter of a tube of a discharge outlet to discharge to a container is smaller than a diameter of a tube linking the foaming unit and a container of the nozzle unit.
